(19) United States
(12) Patent Application Publication
(10) Pub. No.: US 2006/0051191 A1
(43) Pub. Date: Mar. 9, 2006

(54) Barrier sensor apparatus and method

(75) Inventors: James Dupuy, Winamac, IN (US); Fred W. Malchow, Star City, IN (US)

Correspondence Address: MICHAEL BEST & FRIEDRICH LLC, 401 NORTH MICHIGAN AVENUE, SUITE 1900, CHICAGO, IL, 60611-4212, US

(73) Assignee: The Braun Corporation, Winamac, IN (US)

(21) Appl. No.: 11/187,157

(22) Filed: Jul. 22, 2005

Related U.S. Application Data
(60) Provisional application No. 60/590,293, filed on Jul. 22, 2004.

(51) Int. Cl. B60P 1/00

(52) U.S. Cl. 414/522

(57) ABSTRACT

Some embodiments of the present invention provide a sensor which partially or fully disables operation of a vehicle access and entry device when a barrier of the device is moved sufficiently. In some embodiments, the vehicle access and entry device is an inboard barrier of a wheelchair lift, includes a tie rod coupled to the inboard barrier and to a housing, and triggers a sensor when the tie rod is moved sufficiently with respect to the housing.

### CROSS-REFERENCE TO RELATED APPLICATIONS

Priority is hereby claimed to U.S. Provisional Patent Application Ser. No. 60/590,293 filed on Jul. 22, 2004, the entire contents of which are incorporated herein by reference.

### FIELD OF THE INVENTION

The present invention relates to sensor assemblies and methods, and more particularly, to sensor assemblies and methods used in connection with mobility access equipment and devices such as wheelchair lifts, ramps and the like

### BACKGROUND OF THE INVENTION

People having reduced mobility typically require special transportation needs. Among these needs are vehicles equipped with lifting platforms, ramps, moving seats, and other devices for allowing passengers to enter and/or exit vehicles. For example, some devices are used to lift and lower individuals while in their wheelchairs, or to move such individuals in wheelchairs in other manners with respect to a vehicle. It is desirable to safeguard individuals while using these wheelchair lifts, so that the wheelchair does not unintentionally travel beyond the edge of the platform or other portion of the wheelchair lift. As another example, some devices are used to enable stretchers or beds to be loaded onto and/or unloaded from vehicles. It is desirable to safeguard such stretchers or beds from unintentional movement off of the platform or other portion of the vehicle entry and exit device. As yet another example, some devices can be positioned to permit easier entry and exit of individuals to and from vehicles. Such devices include ramps and movable steps that can be moved to different positions with respect to the vehicle to ease entry and exit of individuals. Safety systems for vehicle entry and exit devices are well known and have been employed to ensure the well being of individuals having reduced mobility.

Numerous safety systems for vehicle entry and exit devices have been proposed that include mechanical, electrical, or electromechanical sensing. For a sensor to reliably recognize an object or obstruction on such devices, the sensor must be sensitive to discriminate between the presence of a real obstruction (e.g., a user, wheelchair, stretcher, bed, walker, and the like), and a perceived (e.g., sensor noise or latency) or unimportant obstruction (e.g., a piece of trash or debris). To discriminate between the types of obstructions, sensors (or systems interpreting sensor data), often have set thresholds which necessarily exclude specific sensing ranges.

Other alternative sensing systems include the use of trip switches, pressure sensing devices and the like to detect a load (e.g., a load carried upon a platform, ramp, frame, and the like), such as by detecting hydraulic fluid pressure in excess of a predetermined hydraulic pressure threshold.

### SUMMARY

Some embodiments provide a sensor for controlling one or more operations of a vehicle entry and exit device. The sensor can be a safety mechanism that disables and/or enables operation of any part or all of the vehicle entry and exit device, changes a mode of operation of the device, or controls the device in some other manner.

In some embodiments, the sensor is used to disable and/or enable motion of a vehicle entry and exit device, such as a wheelchair lift, a ramp, a seat moving mechanism, and the like. Although the embodiments of the present invention described below and illustrated in the figures are with reference only to a wheelchair lift, it will be appreciated that such application of the sensor according to the present invention is by way of example only, and that the present invention can be used to control motion of any other vehicle entry and exit device.

Some embodiments are used in connection with a movable barrier of the vehicle entry and exit device, such as a barrier used to prevent movement of an individual off of the device (e.g., a movable barrier connected to a wheelchair lift platform). The barrier can be connected to a barrier sensor by a tie rod. When a force is applied to the barrier, such as would happen when a wheelchair approaches close to an outer edge of the lift platform in some embodiments, the barrier can move the tie rod in order to trigger the sensor. The sensor can send a signal to a controller in order to partially or entirely disable the vehicle entry and exit device. When force is removed from the barrier, the barrier and the tie rod can return to their original positions. The sensor can then send a signal to the control system to enable movement of the vehicle entry and exit device.

In some embodiments, a vehicle access system for user entry into and exit from a vehicle is provided, and comprises a platform movable with respect to the vehicle; an actuator coupled to the platform to move the platform; a barrier coupled to the platform and movable to different positions with respect to the platform; and a sensor in communication with the actuator to detect a position of the barrier, the sensor responsive to detection of the barrier in the position by changing operation of the actuator.

Some embodiments provide a vehicle access system for user entry into and exit from a vehicle, wherein the vehicle access system comprises a platform movable with respect to the vehicle; an actuator coupled to the platform to move the platform; a barrier coupled to the platform and movable to different positions with respect to the platform; and a sensor in communication with the actuator to detect a force applied to the barrier urging the barrier away from a position with respect to the platform, the sensor responsive to detection of the force applied to the barrier by changing operation of the actuator.

In some embodiments, a barrier sensor apparatus for a vehicle access system having a platform movable by an actuator and coupled to a vehicle for user entry into and exit from the vehicle, and a barrier coupled to the platform is provided, and comprises a sensor adapted to communicate with the actuator; and a tie rod coupled to the sensor and movable between a first position and a second position, the sensor detecting the presence of the tie rod in at least one of the first and second positions, and responsive to the detection of the tie rod in the first position by changing operation of the actuator, the tie rod adapted to be coupled to and movable by the barrier between the first and second positions.

Some embodiments provide a method of controlling operation of a vehicle access system for user entry into and exit from a vehicle, wherein the method comprises moving a platform with respect to the vehicle; moving a barrier coupled to the platform to a position with respect to the platform; detecting movement of the barrier away from the position; and changing movement of the platform responsive to detecting movement of the barrier away from the position.

In some embodiments, a method of controlling movement of a vehicle access system for user entry into and exit from a vehicle is provided, and comprises moving a platform with respect to the vehicle; moving a barrier coupled to the platform to a position with respect to the platform; detecting a force applied against the barrier urging the barrier away from the position; and changing a movement of the platform responsive to detecting the force applied against the barrier.

Further aspects of the present invention, together with the organization and operation thereof, will become apparent from the following detailed description of the invention when taken in conjunction with the accompanying drawings.

### BRIEF DESCRIPTION OF THE DRAWINGS

The present invention is described with reference to the accompanying figures, which illustrate embodiments of the present invention. However, it should be noted that the invention as disclosed in the accompanying figures is illustrated by way of example only.

FIG. 1 is a front perspective view of a wheelchair lift system according to an embodiment of the present invention, shown in a extended and raised state;

FIG. 2 is a rear perspective view of the wheelchair lift system illustrated in FIG. 1, shown in an extended and raised state;

FIG. 3 is another front perspective view of the wheelchair lift system illustrated in FIGS. 1 and 2, shown in an extended and lowered state;

FIG. 4 is another rear perspective view of the wheelchair lift system illustrated in FIGS. 1-3, shown in an extended and lowered state;

FIG. 5 is a detail perspective view of the sensor assembly of the wheelchair lift system illustrated in FIGS. 1-4, shown in a first state installed on the wheelchair lift platform;

FIG. 6 is another detail perspective view of the sensor assembly illustrated in FIG. 5, shown in a second state installed on the wheelchair lift platform;

FIG. 7 is another detail perspective view of the sensor assembly illustrated in FIGS. 5 and 6, shown in the first state installed on the wheelchair lift platform;

FIG. 8 is an exploded perspective view of the sensor assembly illustrated in FIGS. 5-7; and

FIG. 9 is a detail perspective view of the sensor assembly, arm, and cam of the wheelchair lift system illustrated in FIGS. 1-8.

### DETAILED DESCRIPTION OF THE EMBODIMENTS

For the purposes of promoting an understanding of the principles of the present invention, reference will now be made to the exemplary embodiments illustrated in the drawings, and specific language will be used to describe the same. It will nevertheless be understood that no limitation of the scope of the invention is thereby intended, such alterations and further modifications in the illustrated device, and such further applications of the principles of the invention as illustrated therein being contemplated would normally occur to one skilled in the art to which the invention relates.

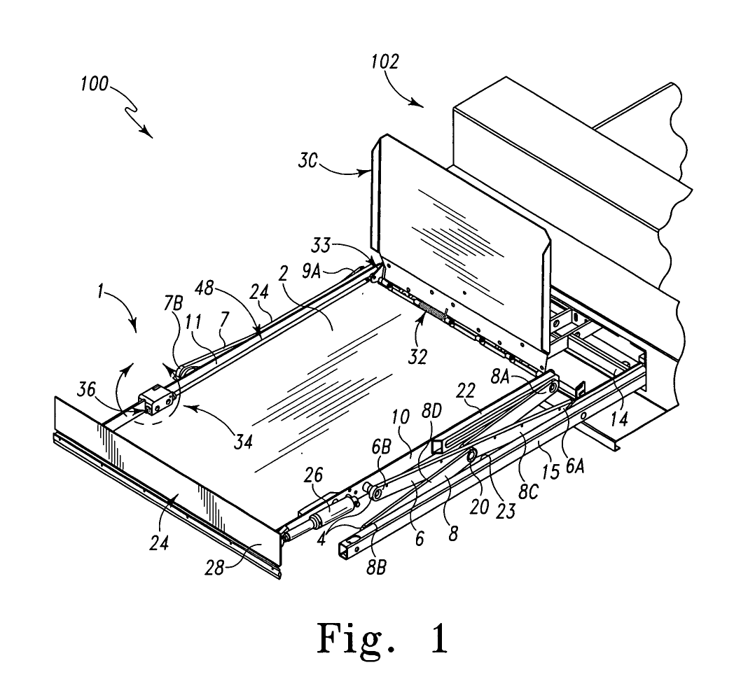

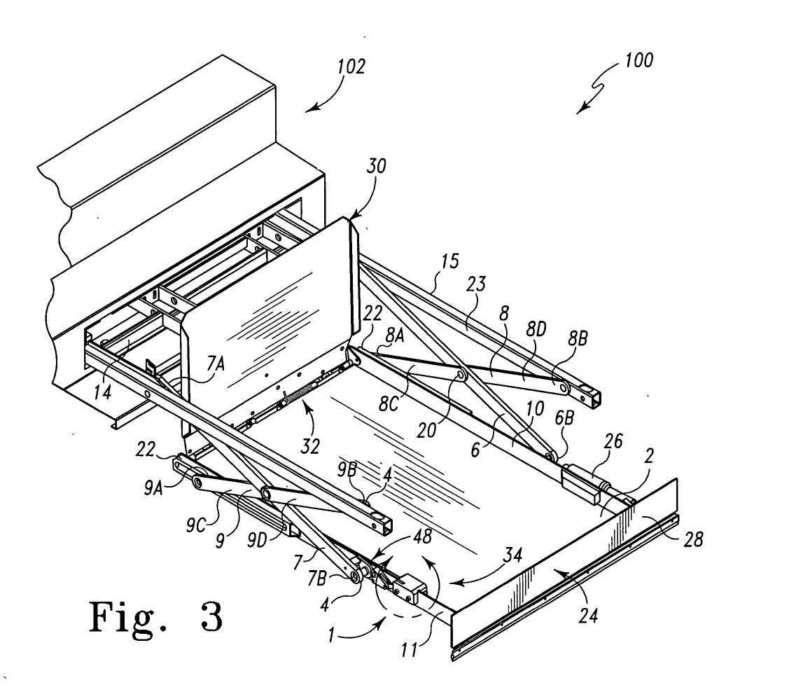

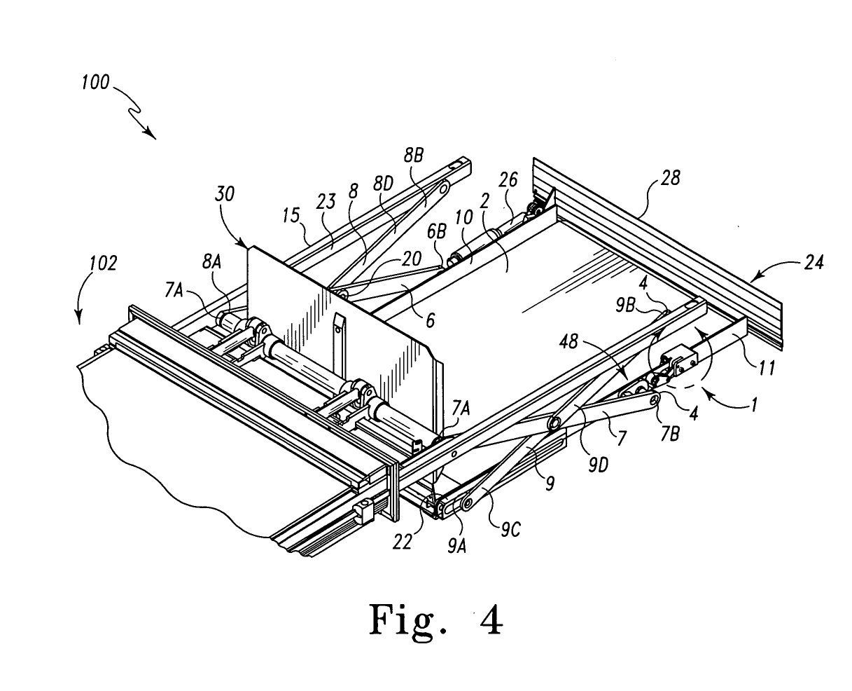

An exemplary application of the sensor apparatus is shown in FIGS. 1-4, which illustrate a wheelchair lift and barrier system. The wheelchair lift (indicated generally at 100) illustrated in FIGS. 1-4 is an under-vehicle scissor-type lift. However, it should be noted that the various embodiments of the barrier system described and illustrated herein (including the barrier 30 and the sensor assembly 1 illustrated in FIGS. 1-4 and described in greater detail below) can be applied to parallelogram-type lifts and to any other type of lift, and can be applied to lifts located anywhere else with respect to a vehicle.

In the application illustrated in FIGS. 1-4, the wheelchair lift becomes disabled when a force is applied to a barrier pivotally connected to a platform of the lift 100. As used herein and in the appended claims, the term “barrier” encompasses any structure or element movable to a position that at least partially blocks user exit from the vehicle lift 100 and/or user entry onto the vehicle lift 100. Such structures and elements can have any shape and size, including without limitation one or more rods, bars, plates, panels, and the like, and can move to the position at least partially blocking user entry and exit by pivotal movement, translational movement, any combination thereof, and/or any other type of movement.

The force causing the lift 100 to become disabled is a force applied to the barrier in a direction away from the lift platform, such as would be generated by an individual or wheelchair approaching the edge of the platform adjacent the barrier. When moved by the force (e.g., pivoted rearward in the illustrated embodiment), the barrier triggers the sensor assembly 1. Although FIGS. 1-4 illustrate an embodiment in which the sensor assembly 1 is coupled to an inboard barrier 30 of a wheelchair lift 100, the sensor assembly 1 could instead be coupled to an outboard barrier or side barrier of the lift 100 with minor modifications known to those in the art, or could be coupled to a barrier of any other vehicle entry and exit device to control movement of the device.

The lift 100 illustrated in FIGS. 1-4 includes a lift platform 2 capable of moving to different levels with respect to a vehicle (indicated generally at 102), such as between the floor level of a vehicle 102 and a ground or other lower surface level. The lift 100 can include a frame 15 and a scissor mechanism 4 to move the platform 2 between such levels. In some embodiments, the platform 2 is connected via the scissor mechanism 4 to a source of power (not shown), such as one or more hydraulic or electric motors, an engine, and the like. One or more other devices can be used to transmit power from the source of power to the scissor mechanism 4 in a manner known to those in the art, such as a hydraulic cylinder, a rack and pinion assembly, and the like. The scissor mechanism 4 can include support links 6, 7 and guide links 8, 9 pivotally connected to the lateral sides 10, 11 of the platform 2 and frame 15. In the illustrated embodiment, the support links 6, 7 are pivotally connected at their inboard ends to the power source and at their outboard ends to the lateral sides 10, 11 of the platform 2. It will be appreciated by those skilled in the art that the scissor mechanism 4 can be attached to the platform 2 in a number of other manners for lifting and lowering the platform 2. Although not shown in the figures, the support and guide links 6, 7, 8, 9, and the other elements of the scissor mechanisms 4 are substantially the same on both lateral sides 10, 11 of the platform 2.

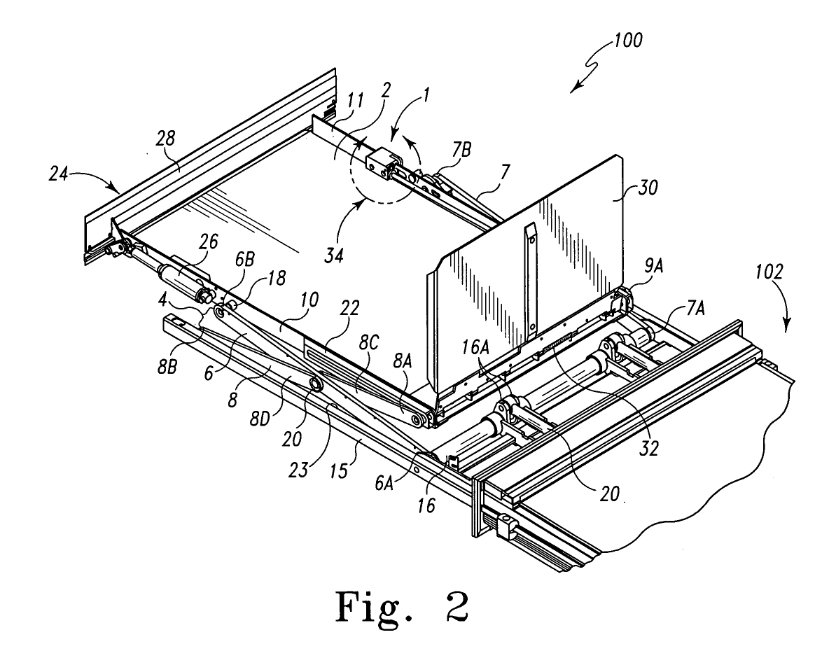

In the illustrated embodiment, the exemplary power source includes hydraulic cylinders 90 (partially visible in FIG. 2). The cylinders 90 are mounted at their inboard ends to a portion of the lift's carriage 14, which travels in and out of the lift housing (otherwise known in the art as the lift “cassette”). The movable rods of the cylinders 90 are coupled to the pivot shaft 16 at cams 16A for rotating the shaft 16 as the cylinders 90 are hydraulically actuated to move the cylinder rods in and out. In the illustrated embodiment, the pivot shaft 16 is connected to the inboard ends 6A and 7A of the support links 6, 7. As the pivot shaft 16 rotates when the hydraulic cylinders 90 are actuated, the scissor mechanisms 4 move such that support links 6, 7 pivot to raise and lower the platform 2.

With continued reference to the illustrated lift 100 of FIGS. 1-4, the outboard ends 6B, 7B of the support links 6, 7 and the inboard ends 8A, 9A of the guide links 8, 9 are pivotally connected to the two lateral sides 10, 11 of the platform 2. Also, the outboard ends 8B, 9B of the guide links 8, 9 are pivotally connected to the frame 15.

The guide links 8, 9 in the illustrated embodiment of FIGS. 1-4 are pivotally connected to their corresponding support links 6, 7 at pivots 20. In some embodiments, the guide links 8, 9 are each a single elongated element extending between pivotal connections to the frame 15 and platform 2 (and pivotally connected to the supporting links 6, 7, in some embodiments). In other embodiments, such as in the illustrated embodiment of FIGS. 1-4, the guide links 8, 9 each have first and second portions 8C, 8D and 9C, 9D extending from the pivotal connection to the support links 6, 7. Alternatively or in addition, the support links 8, 9 can have first and second portions (rather than being a single elongated element as shown in FIGS. 1-4). Still other types of scissor mechanism members and their manners of connection are possible, and are well known to those skilled in the art.

The guide links 8, 9 in FIGS. 1-4 are movable along guides 22 and 23 at or adjacent the lateral edges 10, 11 of the platform 2 and the frame 15, respectively. The guides 22, 23 can take the form of elongated slots in the lateral edges 10, 11 and frame 15, or elongated slots in separate elements attached to the lateral edges 10, 11 and frame 15, and the like. Although the ends 8A, 8B, 9A, and 9B of the guide links 8, 9 are movable along the lateral edges 10, 11 of the platform 2 and the frame 15, respectively, it will be appreciated that in other embodiments, any combination of two or more pivotal connections between the scissor mechanism 4 and the platform 2 and frame 15 can be used to enable the scissor mechanism 4 to raise and lower the platform 2. By way of example only, in some embodiments the inboard ends 6A, 7A, 8A, 9A of the support and guide links 6, 7, 8, 9 are pivotably connected to the platform 2 and frame 15, while the outboard ends 6B, 7B, 8B, 9B of the support and guide links 6, 7, 8, 9 are pivotable and movable along guides. Other combinations of pivotable and translatable connections are possible, and fall within the spirit and scope of the present invention.

In order to prevent individuals, wheelchairs or other objects from moving unintentionally beyond the front end of the platform 2, an outboard barrier 24 can be connected to the front end of the platform 2. The outboard barrier 24 can comprise one or more actuators 26 coupled to a barrier member 28. The actuator(s) 26 can be hydraulic pistons, solenoids, or any other driving device capable of moving the barrier member 28 between a first position in which the barrier member 28 blocks or inhibits movement of objects past the front end of the platform 2, and a second position in which the barrier member 28 does not block or inhibit such movement. The barrier member 28 can take any form capable of performing the foregoing function, such as a plate, bar, frame, belt, or other device or assembly, and in some embodiments can be moved between its positions by a pivotal connection to the platform 2, actuator 26, or other part of the lift 100. In the illustrated embodiment, for example, the barrier member 28 is pivotally connected to the platform 2, and is pivoted by the actuator 26 to a raised position when the lift 100 is in motion, and to a lowered position when the lift 100 is at a desired position (e.g., at ground level).

In order to prevent individuals, wheelchairs or other objects from moving unintentionally beyond the inboard end of the platform 2, an inboard barrier 30 can be used. The inboard barrier 30 is movable between a first position in which the inboard barrier 30 blocks or inhibits movement of objects past the inboard barrier 30 and a second position in which the inboard barrier 30 does not block or inhibit such movement. For example, the inboard barrier 30 in the illustrated embodiment of FIGS. 1-4 is pivotally connected to the platform 2, and is pivotable between a raised and blocking position and a lowered position. In other embodiments, the inboard barrier 30 can be coupled to the lift 100 in other manners and locations. If desired, the inboard barrier 30 can be biased into the raised position, such as by a spring 32.

As shown FIGS. 1-4, the lift 100 can be provided with a barrier sensor assembly (indicated generally at 1). The sensor assembly 1 in the illustrated embodiment of FIGS. 1-4 is connected to the inboard barrier 30 in order to control operation of the lift 100 based upon the position of the inboard barrier 30. However, the sensor assembly 1 can instead be connected to any other barrier to perform a similar function, such as to the outboard harrier 24, to a barrier coupled to a side of the platform 2, and the like.

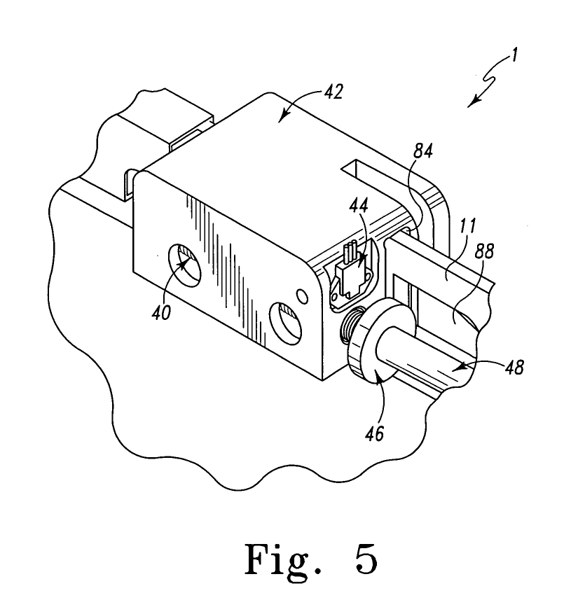

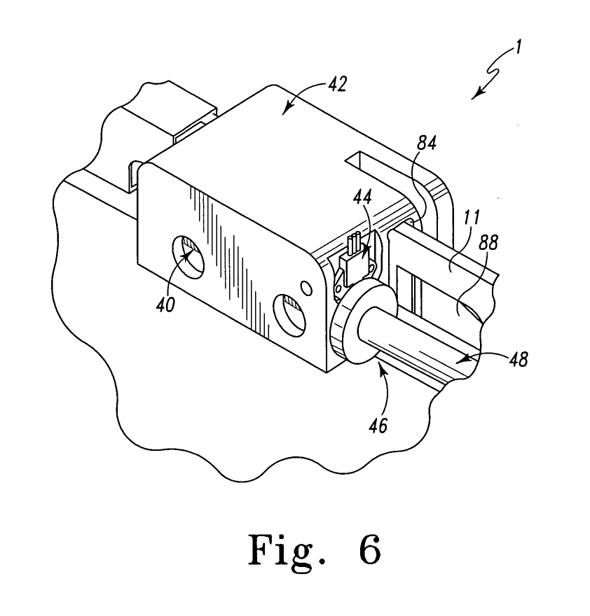

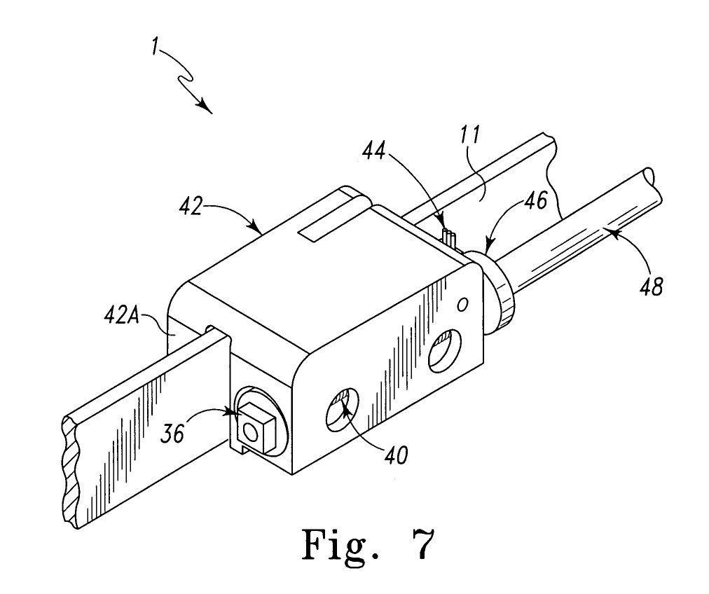

The sensor assembly 1 illustrated in FIGS. 1-4 (and shown in greater detail in FIGS. 5-8) operates to disable the lift 100 when the inboard barrier 30 is moved sufficiently from an at-rest position, such as when force is applied to the inboard barrier 30 to move the inboard barrier 30 in a direction toward the vehicle. Such a force can be generated, for example, by an individual or object on the platform 2 contacting and pushing against the inboard barrier 30 (e.g., from a wheelchair that has approached unacceptably close to the rear of the platform 2, and has pressed against the inboard barrier 30).

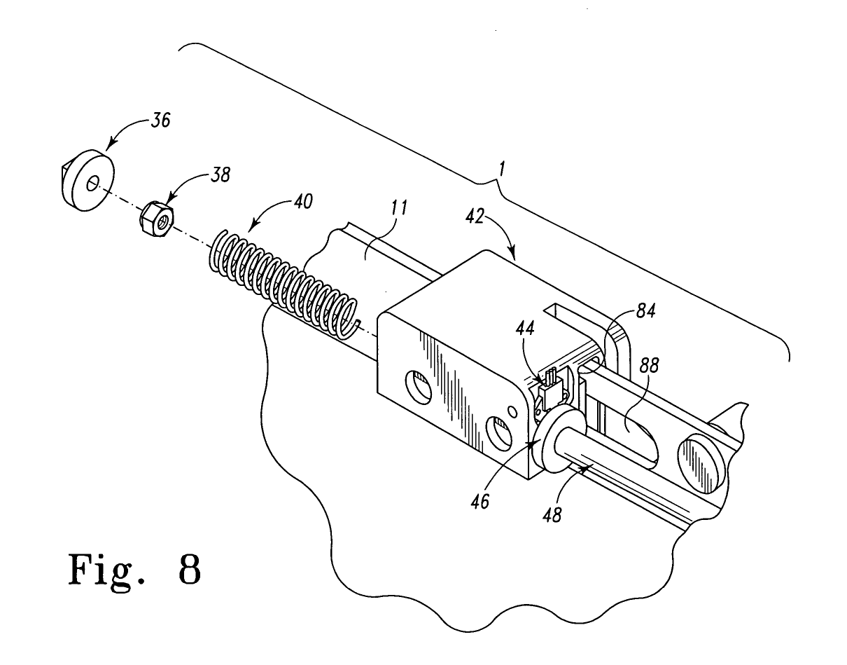

FIG. 8 illustrates an exploded view of the sensor assembly 1 shown in FIGS. 1-7. The illustrated sensor assembly 1 includes a housing 42 and a tie rod 48 movable with respect to the housing 42. The housing 42 can take any form, such as a single integral element as shown in the figures, two or more plates, rods, bars or other elements connected in any suitable manner, and the like. For example, the housing 42 can take the form of an enclosure, a frame, a bracket, and the like, and in some embodiments partially or entirely encloses one or more interior spaces.

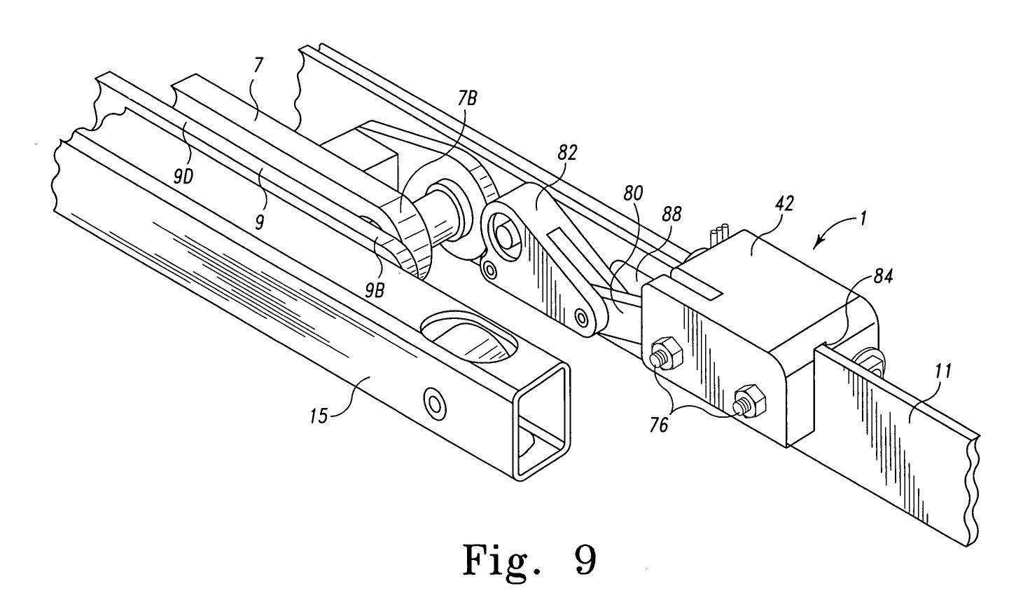

The housing 42 in the illustrated embodiment is connected to a lateral side 11 of the platform 2. In other embodiments, the housing 42 can be connected to other parts of the lift 100, such as to a base of the platform 2, to the frame 15, and the like. The housing 42 can be connected to the lateral side 11 of the platform 2 in any manner, such as by one or more bolts 76 passed through apertures in the housing 42 and platform side 11 (see FIG. 9), by rivets, pins, or other conventional fasteners, by clamps or clips, by inter-engaging elements on the housing 42 and platform side 11, by welding, brazing, adhesive or cohesive bonding material, and the like. However, in some embodiments, the housing 42 is connected to and movable with respect to the platform 2 as will be described in greater detail below.

The tie rod 48 is connected to the inboard barrier 30, and thereby moves when the inboard barrier 30 moves. In the illustrated embodiment, the tie rod 48 is pivotally connected to the inboard barrier 30 by a flange 33 on the inboard barrier 30 adjacent the axis of rotation of the inboard barrier 30 (i.e., near the bottom of the inboard barrier 30 as shown in FIG. 1). However, in other embodiments, the tie rod 48 can be directly or indirectly coupled to the inboard barrier 30 in a number of other manners and locations still generating movement of the tie rod 48 responsive to movement of the inboard barrier 30.

The tie rod 48 in the illustrated embodiment has a magnet 46 attached thereto and movable with the tie rod 48. A sensor 44 on the housing 42 is positioned relative to the magnet 46 to detect at least one position of the tie rod 48. The sensor 44 can be directly or indirectly coupled to and in communication with any actuator of the lift 100, such as to the hydraulic cylinders 90 used to change the elevation of the platform 2. Also, the sensor 44 can be coupled to and in communication with one or more lift controllers (not shown), which are themselves coupled to such actuators. Accordingly, when the inboard barrier 30 is moved (e.g., rotated in the illustrated embodiment), the tie rod 48 can move relative to the housing 42 and sensor 44. The sensor 44 can be located on any exterior wall of the housing 42, can be located partially or entirely within the housing 42, or in any other position in which the sensor 44 can detect the position of the magnet 46. In some embodiments, when the tie rod 48 moves the magnet 46 sufficiently away from the sensor 44, a signal is sent from the sensor 44 to a lift controller (not shown) to at least partially disable the lift 100. Such a signal can be transmitted by one or more electrical wires connecting the sensor 44 to the lift controller or wirejessly by a wireless transmitter connected to the sensor 44 and a wireless receiver connected to the lift controller. In other embodiments, the magnet 46 is instead positioned on the tie rod 48 so that such a signal is sent when the tie rod 48 moves the magnet 46 sufficiently close to the sensor 44.

Although the magnet 46 is connected to the tie rod 48 and the sensor 44 is connected to the housing 42 in the illustrated embodiments, in other embodiments the locations of the magnet 46 and tie rod 48 can be reversed. Also, in other embodiments other types of sensors can be used to detect the position of the tie rod 48 in other ways. By way of example only, the sensor 44 can be an optical sensor positioned to detect any feature on the tie rod 48 (or on the housing 42 or other part of the sensor assembly 1, in those cases where the sensor 44 is connected to the tie rod 48). As another example, the sensor 44 can be a mechanical sensor tripped by sufficient relative movement between the sensor 44 and the tie rod 48 (or housing 42 or other part of the sensor assembly 1, in those cases where the sensor 44 is connected to the tie rod 48). Still other types of sensors can be used, each of which falls within the spirit and scope of the present invention.

In the embodiments of the present invention illustrated in the figures, the sensor 44 detects a position of the inboard barrier 30 by the movement of a tie rod 48 connected to and movable by the inboard barrier 30. However, in other embodiments, other types of elements can be coupled to and movable by the inboard barrier 30 for this purpose, including without limitation plates, bars, fingers, and the like. As used herein, the term “tie rod” refers to and encompasses all such elements. Also, such elements can move in any manner, such as in a translating motion, a pivoting motion, a combination of translating and pivoting motion as shown in the embodiment FIGS. 1-9, and the like.

With continued reference to the illustrated embodiments, in some embodiments the tie rod 48 extends into the housing 42. In such embodiments, the tie rod 48 can extend partially or entirely through the housing 42.

The tie rod 48 can be biased toward a position with respect to the housing 42. In the illustrated embodiment of FIGS. 1-9, for example, the tie rod 48 is biased by a spring 40 coupled to the tie rod 48. As best shown in FIG. 8, the spring 40 is a coil spring received upon the tie rod 48. The spring 40 is located between a spring stop 38 threaded upon the tie rod 48 and an interior wall (not shown) of the housing 42. Therefore, axial movement of the tie rod 48 in a direction toward the inboard barrier 30 causes compression of the spring 40 and generates biasing force urging the tie rod 48 (and the inboard barrier 30) back toward an unbiased position.

In other embodiments, the spring 40 can be positioned in other manners to bias the tie rod 48 as just described. By way of example only, the spring 40 can be located between any part of the housing 42 (e.g., any interior or exterior surface of the housing 42, an element connected to the housing 42, and the like) and any other element permanently or releasably attached to the tie rod 48 (e.g., a pin, finger, flange or other protrusion of or attached to the tie rod 48, a collar of or attached to the tie rod 48 in any suitable manner, and the like). In such cases, force generated by compression of the spring 40 biases the inboard barrier 30 in a direction toward the housing 42. In other embodiments, the spring 40 can be located in still other positions with respect to the tie rod 48 and housing 42 (e.g., not received upon the tie rod 48, located in other positions along the tie rod 48, and the like) while still performing this same function. Also, other types of springs and different spring positions can be used to bias the tie rod 48 as described above. For example, an extension spring can be connected in any suitable manner to the tie rod 48 and the housing 42 for exerting a biasing force when extended by movement of the tie rod 48 in a direction toward the inboard barrier 30. As other examples, one or more leaf springs, magnet sets (e.g., on the tie rod 48 and housing 42, respectively), elastic bands, or other elements (hereinafter referred to as “springs”) can be employed to bias the tie rod 48 toward an at-rest position. It should also be noted that some embodiments of the present invention do not employ a spring 40 to bias the tie rod 48.

In some embodiments, the spring 40 is adjustable so that the spring 40 can exert a selected biasing force upon the tie rod 48 in an at-rest state of the tie rod 48 and/or can exert a desired force or range of forces upon the tie rod 48 when the tie rod 48 is moved from such a state. In the illustrated embodiments, for example, a spring stop 38 is threaded upon the tie rod 48, and can take any form capable of being moved to different positions with respect to the tie rod 48. The spring stop 38 can be a nut, a pin received within different holes along the tie rod 48, a clamp that can be secured to different positions along the tie rod 48, and the like. By changing the position of the spring stop 38, the force needed to move the tie rod 48 away from its at-rest position (e.g., by movement of the inboard barrier 30 with respect to the housing 42) can be adjusted as desired.

Also, some embodiments of the present invention have one or more tie rod stops that limit the amount of motion between the tie rod 48 and the housing 42 in one or more directions. For example, the sensor assembly 1 illustrated in the figures has a tie rod stop 36 located on an end of the tie rod 48, and is positioned to be stopped by the housing 42 (or element connected thereto) when the tie rod 48 is moved sufficiently in a direction toward the inboard barrier 30. The tie rod stop 36 can be threaded upon an end of the tie rod 48 or can be attached thereto in any manner. Also, the tie rod stop 36 can take any form capable of limiting tie rod motion, such as any of the forms of the spring stop 38 described above. Furthermore, the tie rod stop 36 can be adjustable to different positions with respect to the tie rod 48 in order to change the range of motion of the tie rod 48 with respect to the housing 42. In the illustrated embodiments, the tie rod stop 36 is a collared nut threaded onto an end of the tie rod 48 and movable with respect to the housing 42 when the tie rod 48 is moved with respect to the housing 42. The tie rod stop 36 in the illustrated embodiment abuts a wall of the housing 42 when the tie rod 48 has moved sufficiently with respect to the housing 42 in a direction toward the inboard barrier 30. The tie rod stop 36 can be stopped by any part of the housing 42, such as an internal or external wall of the housing 42, the bottom of a counterbore in the housing 42, and the like, and can be used to limit the amount of force placed upon the spring 40.

In operation, when the inboard barrier 30 is in a position with respect to the platform 2, the tie rod 48 extends a distance from the flange 33 (or other inboard barrier connection location) to the housing 42 of the sensor assembly 1. However, when the inboard barrier 30 is moved from this position without other movement of the housing 42 relative to the flange 33, the magnet 46 moves with respect to the sensor 44. When such movement is sufficient to trigger the sensor 44 (i.e., moving the magnet 46 sufficiently away from the sensor 44 in the illustrated embodiment), a signal is sent to the lift controller (not shown) to disable part or all of the lift 100. When the inboard barrier 30 is returned to its at-rest position, such as under force from the spring 40 or in any other manner, the sensor 44 can send another signal to enable part or all of the lift 100 or to at least provide an indication that the inboard barrier 30 has returned to its at-rest position.

As described above, the sensor assembly 1 in the illustrated embodiments is responsive to sufficient force applied to and movement of the inboard barrier 30 by sending a signal to disable part or all of the lift 100 (e.g., disabling a the power source to the lift, such as the hydraulic cylinders 90). In other embodiments, the sensor assembly 1 can instead respond to such force by changing movement of the platform 2 or any other part of the vehicle lift 100 in any other manner. For example, the sensor assembly 1 can be coupled to and control movement of the actuator 26 of the outboard barrier 24, one or more hydraulic actuators, motors, or other power sources coupled to the frame 15 for moving the frame 15 outwardly or inwardly with respect to the vehicle 102, and the like. The sensor assembly 1 can be coupled to and control movement of two or more actuators associated with two or more different portions of the lift 100. Also, the sensor assembly 1 can be responsive to sufficient force applied to and/or movement of the inboard barrier 30 by changing movement of the platform 2 or other lift components in other manners, such as by slowing or reversing platform movement (rather than just stopping such movement by disabling an actuator), and/or slowing, stopping, or reversing movement of any other lift component(s).

In some embodiments, it is desirable to enable movement of the inboard barrier 30 with respect to the platform 2 and/or other portions of the lift 100 without triggering the sensor 44. For example, in some embodiments it is desirable to change the position of the inboard barrier 30 at different lift positions without triggering the sensor 44. In the illustrated embodiments for example, the inboard barrier 30 can be pivoted to different orientations with respect to the platform 2 when the lift 100 is moved to different elevations (e.g., a substantially horizontal inboard barrier orientation when the lift 100 is raised to a vehicle floor height or other height, a substantially vertical inboard barrier orientation when the lift 100 is lowered to a ground height or other height). In these and other cases, the housing 42 of the sensor assembly 1 can be moved with respect to the platform 2, platform edges 10, 11, or other lift element(s) to which the housing 42 is connected as described above.

Such movement can be generated in a number of different manners known to those skilled in the art. For example, the housing 42 illustrated in the figures can be pivotably coupled to an arm 80 (see FIG. 9) that moves in response to movement of the lift 100. More specifically, the arm 80 in the illustrated embodiments is pivotably coupled to the housing 42 and to a cam 82 coupled to the lift 100. The housing 42 can be coupled to the side 11 of the platform 2 or along any other part of the lift 100 as described above, and can be movable with respect to the side 11 of the platform 2 in any manner, such as by a slot, groove, or other aperture in the housing 42 slidably receiving the side 11 of the platform 2, by being pivotably coupled to the platform 2, and the like. In the illustrated embodiments for example, the housing 42 has an aperture 84 in which the side 11 of the platform 2 is slidably received, and is connected to the side 11 of the platform 2 by bolts 76. The bolts 76 can be received within elongated apertures 88 in the side 11 of the platform 2, thereby enabling movement of the housing 42 with respect to the platform 2.

When the cam 82 in the illustrated embodiments is rotated (such as by an outboard end 7A of a control link 7 or by an element coupled thereto when the control link 7B is rotated as the lift 100 is raised or lowered), the cam 82 moves the arm 80. By moving the arm 80, the housing 42 is moved along the side 11 of the platform 2. The cam 82 can be shaped and can be positioned with respect to the control link 7 such that the housing 42 is pushed in a direction away from the inboard barrier 30 when the lift 100 is lowered, and is drawn in a direction toward the inboard barrier 30 when the lift 100 is raised. Alternatively, the cam 82 can be shaped and can be positioned with respect to the control link 7 such that the housing 42 is moved in any other manner desired (e.g., pushed in a direction toward the inboard barrier 30 when the lift 100 is lowered, and drawn in a direction away from the inboard barrier 30 when the lift 100 is raised, moved in either direction only during part of the vertical range of motion of the lift 100, and the like).

In other embodiments, the housing 42 of the sensor assembly 1 can be moved with respect to the platform 2 in any other manner, such as by a pneumatic or hydraulic actuator, a solenoid, other mechanical connections between the housing 42 and the rest of the lift 100, and the like.

With reference to the illustrated embodiments, when force is applied to the inboard barrier 30 in a direction urging the inboard barrier 30 toward a lowered position, the flange 33 on the inboard barrier 30 is pivoted, which in turn causes the tie rod 48 to move with respect to the housing 42. This movement causes the spring 40 to compress, and moves the magnet 46 away from the sensor 44. Movement of the inboard barrier 30 in the sane direction can be limited by the tie rod stop 36, if used. When the magnet 46 has moved sufficiently with respect to the sensor 44 (by movement of the tie rod 48), a signal is sent to the lift controller to disable part or all of the lift 100, such as to disable further lift movement.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A vehicle access system for user entry into and exit from a vehicle, the vehicle access system comprising:
a platform movable with respect to the vehicle;
an actuator coupled to the platform to move the platform;
a barrier coupled to the platform and movable to different positions with respect to the platform; and
a sensor in communication with the actuator to detect a position of the barrier, the sensor responsive to detection of the barrier in the position by changing operation of the actuator.

2. The vehicle access system as claimed in claim 1, wherein the sensor is responsive to detection of the position of the barrier by at least one of stopping, slowing, and reversing movement of the platform.

3. The vehicle access system as claimed in claim 1, wherein:
the platform has an inboard side adjacent the vehicle, and an outboard side opposite the inboard side; and
the barrier is located proximate the inboard side of the platform.

4. The vehicle access system as claimed in claim 1, wherein the barrier at least partially blocks user exit from the platform past the barrier in at least one position of the barrier.

5. The vehicle access system as claimed in claim 1, further comprising a magnet movable with respect to the sensor, wherein the sensor detects the position of the barrier by detection of the magnet.

6. The vehicle access system as claimed in claim 1, wherein the sensor is coupled to the barrier by a tie rod.

7. The vehicle access system as claimed in claim 6, wherein the tie rod is movable by movement of the barrier with respect to the platform.

8. The vehicle access system as claimed in claim 6, further comprising a housing coupled to the platform and in which the tie rod is movable, wherein the housing is movable to different positions with respect to the platform responsive to movement of the platform with respect to the vehicle.

9. A vehicle access system for user entry into and exit from a vehicle, the vehicle access system comprising:
a platform movable with respect to the vehicle;
an actuator coupled to the platform to move the platform;
a barrier coupled to the platform and movable to different positions with respect to the platform; and
a sensor in communication with the actuator to detect a force applied to the barrier urging the barrier away from a position with respect to the platform, the sensor responsive to detection of the force applied to the barrier by changing operation of the actuator.

10. The vehicle access system as claimed in claim 9, wherein the sensor is responsive to detection of the force applied to the barrier by at least one of stopping, slowing, and reversing movement of the platform.

11. The vehicle access system as claimed in claim 9, wherein:
the platform has an inboard side adjacent the vehicle, and an outboard side opposite the inboard side; and
the barrier is located proximate the inboard side of the platform.

12. The vehicle access system as claimed in claim 9, wherein the barrier at least partially blocks user exit from the platform past the barrier when the barrier is in the position.

13. The vehicle access system as claimed in claim 9, further comprising a magnet movable with respect to the sensor, wherein the sensor detects the force applied to the barrier by detection of the magnet.

14. The vehicle access system as claimed in claim 9, wherein the sensor is coupled to the barrier by a tie rod.

15. The vehicle access system as claimed in claim 14, wherein the tie rod is movable by movement of the barrier with respect to the platform.

16. The vehicle access system as claimed in claim 14, further comprising a housing coupled to the platform and in which the tie rod is movable, wherein the housing is movable to different positions with respect to the platform responsive to movement of the platform with respect to the vehicle.

17. A barrier sensor apparatus for a vehicle access system having a platform movable by an actuator and coupled to a vehicle for user entry into and exit from the vehicle, and a barrier coupled to the platform, the barrier sensor apparatus comprising:
a sensor adapted to communicate with the actuator; and
a tie rod coupled to the sensor and movable between a first position and a second position, the sensor detecting the presence of the tie rod in at least one of the first and second positions, and responsive to the detection of the tie rod in the first position by changing operation of the actuator, the tie rod adapted to be coupled to and movable by the barrier between the first and second positions.

18. The barrier sensor apparatus as claimed in claim 17, wherein the sensor is responsive to the detection of the tie rod in the first position by at least one of stopping, slowing, and reversing movement of the platform.

19. The barrier sensor apparatus as claimed in claim 17, wherein:
the platform has an inboard side adjacent the vehicle, and an outboard side opposite the inboard side; and
the barrier is located proximate the inboard side of the platform.

20. The barrier sensor apparatus as claimed in claim 17, wherein the barrier at least partially blocks user exit from the platform past the barrier when the barrier is in a position corresponding to the second position of the tie rod.

21. The barrier sensor apparatus as claimed in claim 17, further comprising a magnet movable with respect to the sensor, wherein the sensor detects the presence of the tie rod in at least one of the first and second positions by detection of the magnet.

22. The barrier sensor apparatus as claimed in claim 17, further comprising a housing coupled to the platform and in which the tie rod is movable, wherein the housing is movable to different positions with respect to the platform responsive to movement of the platform with respect to the vehicle.

23. A method of controlling operation of a vehicle access system for user entry into and exit from a vehicle, the method comprising:
moving a platform with respect to the vehicle;
moving a barrier coupled to the platform to a position with respect to the platform;
detecting movement of the barrier away from the position; and
changing movement of the platform responsive to detecting movement of the barrier away from the position.

24. The method as claimed in claim 23, wherein changing movement of the platform comprises at least one of stopping, slowing, and reversing movement of the platform.

25. The method as claimed in claim 23, further comprising positioning the barrier proximate an inboard side of the platform adjacent the vehicle.

26. The method as claimed in claim 23, wherein moving the platform comprises changing an elevation of the platform with respect to the vehicle.

27. The method as claimed in claim 23, wherein moving the barrier comprises moving the barrier to a position in which the barrier at least partially blocks user exit from the platform past the barrier.

28. The method as claimed in claim 23, wherein detecting movement of the barrier comprises detecting movement of the barrier with a sensor, the method further comprising moving the sensor with respect to the platform.

29. The method as claimed in claim 28, wherein moving the sensor with respect to the platform comprises moving the sensor responsive to movement of the platform.

30. A method of controlling movement of a vehicle access system for user entry into and exit from a vehicle, the method comprising:
moving a platform with respect to the vehicle;
moving a barrier coupled to the platform to a position with respect to the platform;
detecting a force applied against the barrier urging the barrier away from the position; and
changing a movement of the platform responsive to detecting the force applied against the barrier.

31. The method as claimed in claim 30, wherein changing the movement of the platform comprises at least one of stopping, slowing, and reversing movement of the platform.

32. The method as claimed in claim 30, further comprising positioning the barrier proximate an inboard side of the platform adjacent the vehicle.

33. The method as claimed in claim 30, wherein moving the platform with respect to the vehicle comprises changing an elevation of the platform with respect to the vehicle.

34. The method as claimed in claim 30, wherein moving the barrier comprises moving the barrier to a position in which the barrier at least partially blocks user exit from the platform past the barrier.

35. The method as claimed in claim 30, wherein detecting the force applied against the barrier comprises detecting movement of the barrier with a sensor, the method further comprising moving the sensor with respect to the platform.

36. The method as claimed in claim 35, wherein moving the sensor with respect to the platform comprises moving the sensor responsive to movement of the platform.
